(19) United States
(12) Patent Application Publication
(10) Pub. No.: US 2008/0103641 A1
(43) Pub. Date: May 1, 2008

(54) Methods and apparatus for overlaying non-georeferenced symbology on a georeferenced chart

(75) Inventor: Thomas L. Ratcliffe, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/590,326

(22) Filed: Oct. 31, 2006

(51) Int. Cl. G01C 23/00

(52) U.S. Cl. 701/3

(57) ABSTRACT

Methods and apparatus are provided for displaying flight hazard data on a display in an aircraft. In one embodiment, by way of example only, a method includes displaying an electronic aeronautical chart comprising georeferenced formatted data, converting non-georeferenced flight hazard data into a georeferenced format, and displaying the converted flight hazard data on the electronic aeronautical chart

### FIELD OF THE INVENTION

The present invention generally relates to aircraft flight management system displays and, more particularly, to a flight management system display that overlays non-georeferenced symbology onto a georeferenced electronic aeronautical chart.

### BACKGROUND OF THE INVENTION

Aeronautical charts include key information for use during an aircraft flight. For instance, aeronautical charts contain navigation information, such as airport map data, airport approach data, airspace data, and/or procedural information, such as airport departure and arrival procedure data. The charts are typically available in paper-form and disposed in a binder so that the information contained thereon, which frequently becomes obsolete, may be regularly replaced.

Typically, each pilot is issued a flight bag within which the aeronautical chart binders are maintained. Before a flight, the pilot is responsible for physically updating the charts he may need during the flight and to transport his flight bag onto the aircraft he will operate. Depending on the length and/or complexity of the flight path, the pilot may need to refer to hundreds of pages of aeronautical charts; thus, the flight bag may, consequently, be relatively heavy. Additionally, in some cases, numerous binders may be needed, which may occupy a large volume of space onboard the aircraft.

To alleviate this weight and space issue, certain suppliers provide electronic-versions of these charts. The electronic versions are presented in a .jpeg-type or .pdf-type image allowing the pilot to view the chart as if it was on a sheet of paper. In most cases, the electronic-versions of the charts are loaded onto an aircraft computer system, a laptop computer, or a personal digital assistant-type of device, thus allowing relatively easy access thereto on the aircraft or transportation thereof from aircraft to aircraft.

Although the electronic versions have many advantages, they still have certain drawbacks. For instance, because the electronic versions are presented as .jpeg-type or .pdf-type images, the pilot can reduce or magnify selected portions thereof, but cannot otherwise interact with the image. Additionally, the pilot may need to refer to one or more pages of the electronic aeronautical charts in conjunction with real-time flight hazards such as terrain, traffic, or weather. The real-time flight hazards may be displayed on a screen or a portion of a screen that is separate from the electronic aeronautical chart or may be provided to the pilot audibly. In some cases, such as when an instantaneous flight operation decision may need to be made, it may be relatively burdensome for the pilot to process data obtained from two different displays or two different sources.

Accordingly, it is desirable to have a system that presents the electronic aeronautical charts in a more user-friendly format. More particularly, it is desirable to present the electronic aeronautical charts in a format that is easier to process with other flight hazard data. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Methods and apparatus are provided for displaying flight hazard related data on a display in an aircraft. In one embodiment, by way of example only, a method includes displaying an electronic aeronautical chart comprising georeferenced formatted data, converting non-georeferenced flight hazard data into a georeferenced format, and displaying the converted flight hazard data on the electronic aeronautical chart.

In another embodiment, by way of example only, a display system includes a processor and a display. The processor is adapted to receive georeferenced formatted data representing an electronic aeronautical chart, to receive and convert non-georeferenced flight hazard data into a georeferenced format, and operable, in response to receiving and converting, to supply one or more image rendering display commands. The display device is coupled to receive the image rendering display commands and operable, in response thereto, to simultaneously render the converted flight hazard data on the electronic aeronautical chart.

### BRIEF DESCRIPTION OF THE DRAWINGS

The present invention will hereinafter be described in conjunction with the following drawing figures, wherein like numerals denote like elements, and wherein:

FIG. 1 is a functional block diagram of an exemplary flight management system;

FIG. 2 is a simplified representation of an exemplary display screen that may be used in the system of FIG. 1, which shows the overall layout of the display screen, and on which is various graphical and textual images are simultaneously displayed; and

FIGS. 3-5 are representations of exemplary images that may be displayed on the display screen shown in FIG. 2.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

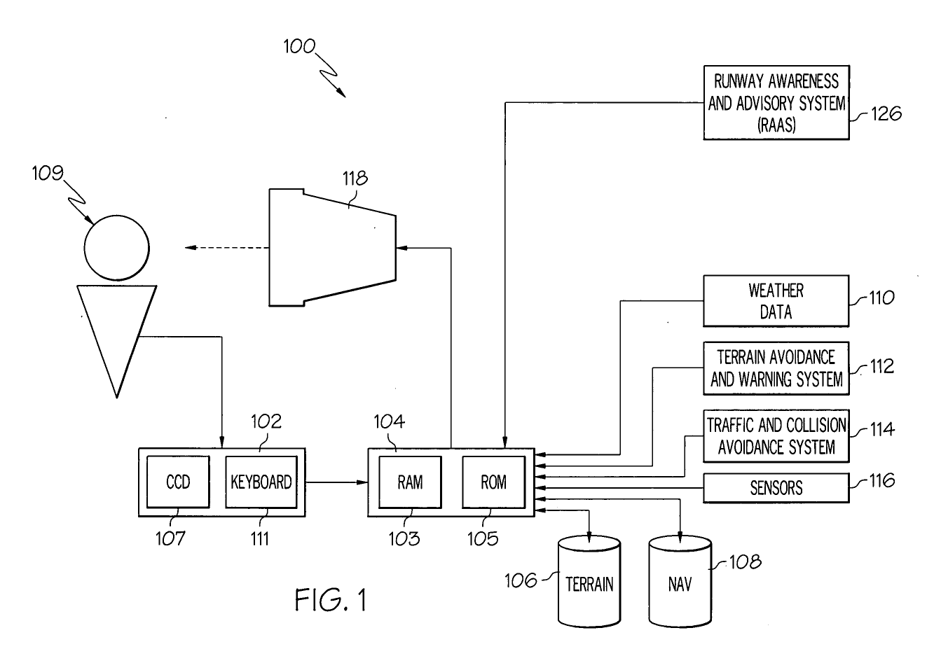

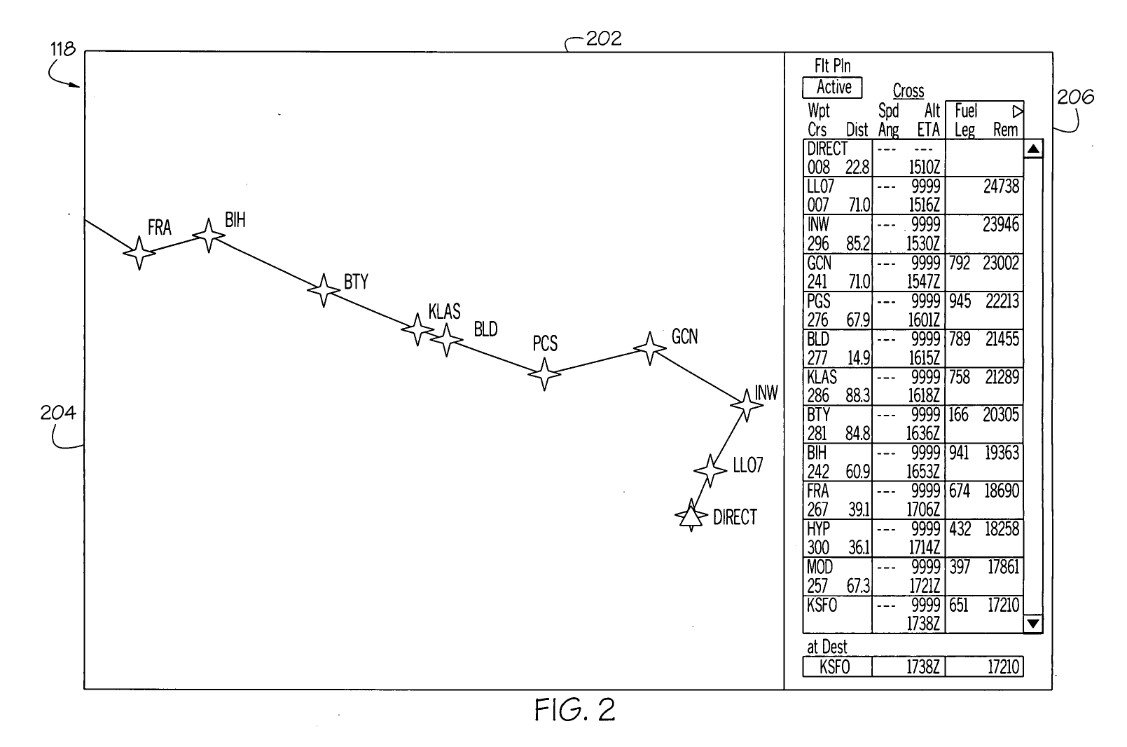

Turning now to the description, and with reference to FIG. 1, an exemplary flight deck display system will be described. The system 100 includes a user interface 102, a plurality of flight hazard detection sensors, a processor 104, and a display device 118. The user interface 102 is in operable communication with the processor 104 and is configured to receive input from a user 109 (e.g., a pilot) and, in response to the user input, supply command signals to the processor 104. The user interface 102 may be any one, or combination, of various known user interface devices including, but not limited to, a cursor control device (CCD) 107, such as a mouse, a trackball, or joystick, and/or a keyboard, one or more buttons, switches, or knobs. In the depicted embodiment, the user interface 102 includes a CCD 107 and a keyboard 111. The user 109 uses the CCD 107 to, among other things, move a cursor symbol on the display screen (see FIG. 2), and may use the keyboard 111 to, among other things, input textual data.

The flight hazard detection sensors either store, receive, and/or generate data that can be supplied to the processor 104 for processing and generating commands to the display device 118. The flight hazard detection sensors include one or more terrain databases 106 and weather data sources 110, aircraft sensor systems, such as a terrain avoidance and warning system (“TAWS”) 112, a traffic and collision avoidance system (“TCAS”) 114, and other various sensors 116. The terrain databases 106 include data representative of the terrain over which the aircraft is flying, such as elevation data. The navigation databases 108 include various types of navigation-related data. These navigation-related data include various flight plan related data such as, for example, electronic aeronautical charts that show waypoints, distances between waypoints, headings between waypoints, data related to different airports, navigational aids, obstructions, special use airspace, political boundaries, communication frequencies, and other information that may be related to aircraft en route, aircraft arrival, aircraft approach, and or aircraft departure. Although the terrain databases 106 and the navigation databases 108 are, for clarity and convenience, shown as being stored separate from the processor 104, all or portions of either or both of these databases 106, 108 could be loaded into the on-board RAM 103, or integrally formed as part of the processor 104, and/or RAM 103, and/or ROM 105. The terrain databases 106 and navigation databases 108 could also be part of a device or system that is physically separate from the display system 100.

The weather data 110 supplied to the processor 104 may be representative of at least the location and type of various weather cells. The TAWS 112 supplies data representative of the location of terrain that may be a hazard to the aircraft. The data supplied from the TCAS 114 includes data representative of other aircraft in the vicinity, which may include, for example, speed, direction, altitude, and altitude trend. The avionics data that is supplied from the sensors 116 includes data representative of the state of the aircraft such as, for example, aircraft speed, altitude, and heading. The sensors 116 may also sense real-time aircraft positioning data that may be supplied to a global positioning system or an inertial reference system.

It will be appreciated that the above-described flight hazard data may be received and/or stored in a georeferenced format or a non-georeferenced format. Georeferenced formatted data are based, at least in part, on global positioning data, and are thus stored or received as one or more geographic coordinates (latitude, longitude). Specific examples of data typically received as or stored in a georeferenced format include electronic aeronautical charts that depict flight routes, airport maps, and global positioning of fixed objects at the airport, such as runway locations, hangar locations, control locations, and the like that may be related to aircraft en route, approach, arrival, and/or departure. Non-geo-referenced formatted data are stored or received in any format other than a geographic coordinate. For example, non-georeferenced formatted data may be in a bearing/distance format. In some cases, georeferenced formatted data may be associated with non-georeferenced formatted data, such as altitude, heading, direction, or other trajectory data.

In addition to the above-mentioned flight hazard detection sources, other external systems may also supply hazard related data to the processor 104. For example, these external systems may include a runway awareness and advisory system (RAAS) 126. The RAAS 126 provides improved situational awareness to help lower the probability of runway incursions by providing timely aural advisories to the flight crew during taxi, takeoff, final approach, landing and rollout. The RAAS 126 uses global positioning data to determine aircraft position and compares aircraft position to airport location data stored in the navigation database 108. Based on these comparisons, the RAAS 126, if necessary, issues appropriate aural advisories. The aural advisories the RAAS 126 may issue inform the pilot 109, among other things of when the aircraft is approaching a runway—either on the ground or from the air, when the aircraft has entered and is aligned with a runway, when the runway is not long enough for the particular aircraft, the distance remaining to the end of the runway as the aircraft is landing or during a rejected takeoff, when the pilot 109 inadvertently begins to take off from a taxiway, and when an aircraft has been immobile on a runway for an extended time.

As briefly mentioned above, the processor 104 is in operable communication with the flight hazard data sources (e.g., the terrain databases 106, source of weather data 110, TAWS 112, TCAS 114) and the display device 118 and is coupled to receive various types of data from the various sensors 116, and various other aircraft flight-related data from one or more of the external systems. Specifically, the processor 104 is configured to selectively retrieve georeferenced formatted data from one or more of the flight-related data sources, and to supply appropriate display commands to the display device 118, so that the retrieved data are appropriately displayed on the display device 118. The processor 104 is also configured to selectively retrieve non-georeferenced formatted data from one or more of the flight hazard data sources, and to supply appropriate display commands to the display device 118, so that the retrieved data are appropriately displayed on the display device 118. In this regard, the processor 104 is further configured to convert the selectively retrieved non-georeferenced formatted flight hazard data into a georeferenced format and to supply commands to the display device 118 to simultaneously display the converted data with the georeferenced formatted data on the display device 118. Additionally, the processor 104 may be further configured to associate the converted data with certain non-georeferenced formatted data, such as trajectory data. The preferred manner in which the data are displayed on the display device 118 will be described in more detail further below.

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used.

The display device 118 is used to display various images and data, in both a graphical and a textual format, and to supply visual feedback to the user 109 in response to the user input commands supplied by the user 109 to the user interface 102. It will be appreciated that the display device 118 may be any one of numerous known displays suitable for rendering image and/or text data in a format viewable by the user 109. Non-limiting examples of such displays include various cathode ray tube (CRT) displays, and various flat panel displays such as, various types of LCD (liquid crystal display) and TFT (thin film transistor) displays. The display may additionally be based on a panel mounted display, a HUD projection, or any known technology. In an exemplary embodiment, display element 104 includes a panel display. To provide a more complete description of the method that is implemented by the flight management system 100, a general description of the display device 118 and its layout will now be provided.

With reference to FIG. 2, it seen that the display device 118 includes a display area 202 in which multiple graphical and textual images may be simultaneously displayed, preferably in different sections of the display area 202. For example, the display area 202 may include a graphical display area 204 and a textual display area 206. The graphical display area 204 may display a lateral situational view, vertical view, or a perspective view, or any combination of the views, of an image relating to flight data. The textual display area 206 displays text that may need to be communicated to the pilot 109.

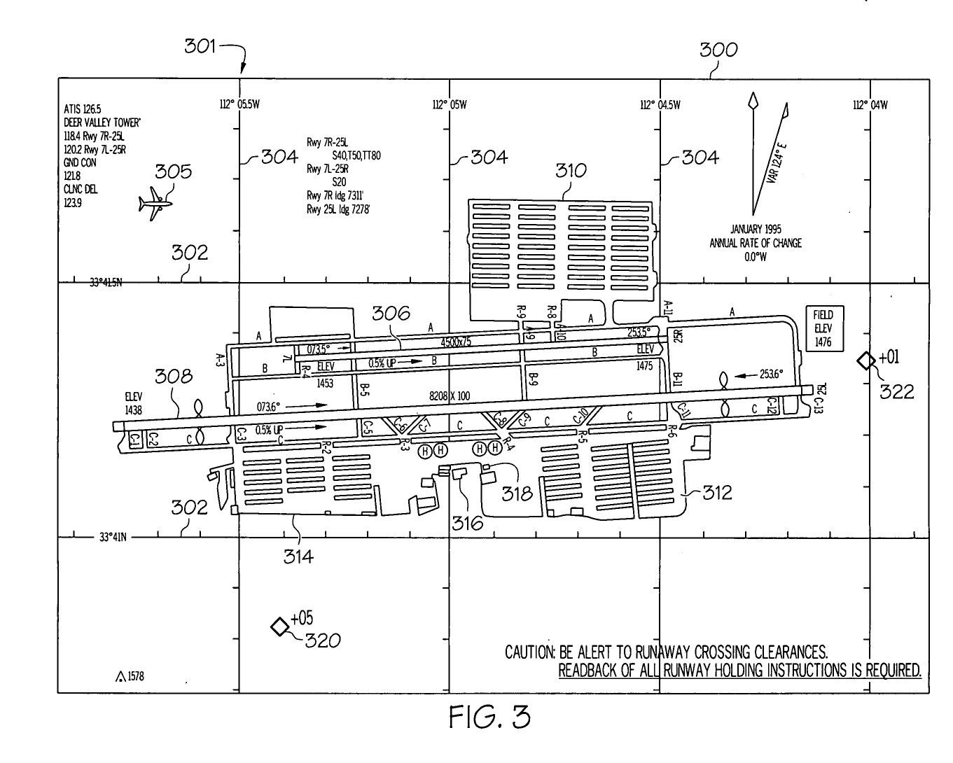

The graphical display area 204 may display images that include georeferenced formatted data displayed in conjunction with non-georeferenced flight hazard data that has been converted into a georeferenced format. The graphical display area 204 may include textual and/or numerical information as well. An exemplary embodiment of such an image 300 that may be shown in the graphical display area 204 is illustrated in FIG. 3. The image 300 shows an electronic aeronautical chart that includes a plurality of airport objects. Because the airport objects are in fixed locations, they have global positions identified by geographic coordinates that may be stored in one of the aforementioned databases. Any one of numerous types of airport objects may be represented on the image 300, such as, for example, one or more runways 306, 308, hangars 310, 312, 314, terminals 316, and a control tower 318. An aircraft symbol 305 representing the pilot's 109 aircraft also appears and is shown at a position that represents its location relative to the airport objects. In this embodiment, the image 300 includes a grid 301 having a plurality of latitude lines 302 and longitude lines 304 which provide immediate visual information regarding the global positioning of the pilot's aircraft and airport objects.

As alluded to above, converted non-georeferenced formatted data are also displayed in the grid 301. In this regard, the processor 104 selectively retrieves non-georeferenced formatted data from one or more appropriate flight hazard data sources, and converts the non-georeferenced formatted data into a georeferenced format. It will be appreciated that any non-georeferenced formatted data capable of being converted into a geographic coordinate, may be retrieved and displayed as part of the image 300. In one example, as shown in FIG. 3, traffic data, conventionally received by an aircraft in a non-georeferenced format and stored or sensed by the aircraft in an airborne bearing/distance format (bearing/distance relative to the pilot's aircraft), is converted into geographic coordinates. In this case, conversion may be performed using any one of numerous formulae, such as, for example, a partial earth distance formula, a whole earth formula, or other suitable formula. The traffic data are then displayed as traffic indicator symbols 320, 322 indicating other air traffic positions relative to the fixed airport objects.

As mentioned above, the converted non-georeferenced formatted data may be associated with trajectory data associated with the flight hazard. For example, as shown in FIG. 3, the traffic indicator symbols 320, 322 may be associated with relative altitude data. Here, one of the traffic indicator symbols 320 includes a “+01”, indicating that a target aircraft has a position that is 100 feet above a given altitude at which the user's aircraft is positioned. The other traffic indicator symbol 322 includes a “+05”, which indicates that a second target aircraft has a position that is 500 feet above the user's aircraft. It will be appreciated that the non-georeferenced formatted data may be dynamic; thus, the data may need to be continuously uploaded, converted, and displayed over a predetermined period of time. For example, in FIG. 3, the positioning of the traffic indicator symbols 320, 322 relative to the latitude and longitude lines 302, 304 and relative altitude data may change over time.

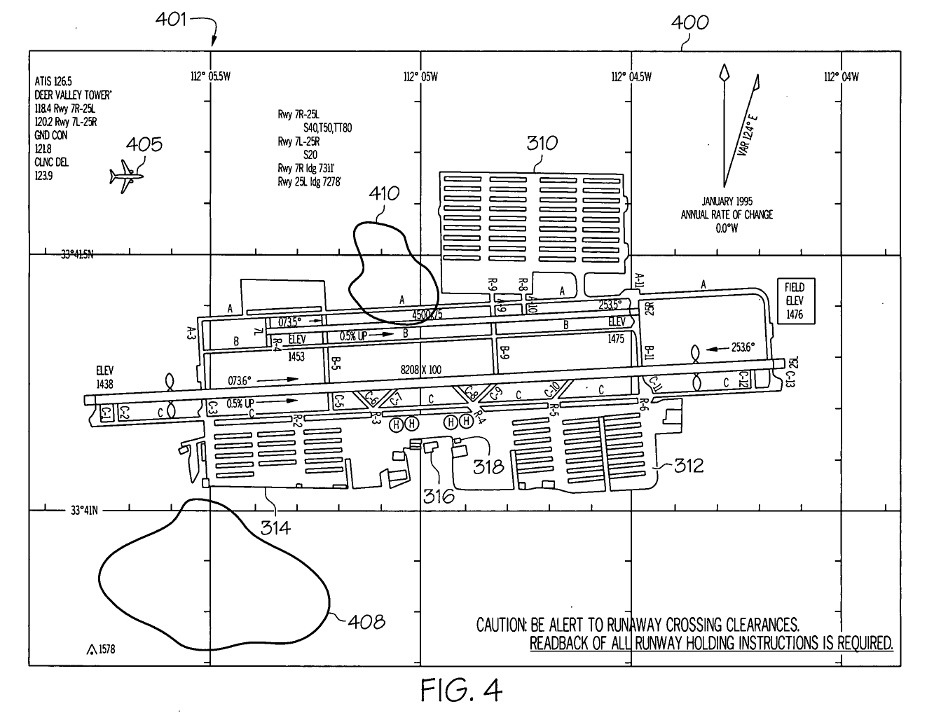

In other exemplary embodiments, the non-georeferenced formatted flight hazard data may be weather data. For example, FIG. 4 depicts an image 400 of an electronic aeronautical chart that includes a grid 401, an aircraft symbol 405, and airport objects. The image 400 also includes a first and a second storm cell 408, 410 and provides the user 109 with immediate visual information indicating global positioning of the storm cells 408, 410 and relative location of the storm cells 408, 410 with regard to the airport objects and the user's aircraft. To display the image 400, the processor 104 retrieves data from the weather data source 110. The weather data source 110, which receives and stores data in a non-georeferenced format is converted to geographic coordinates, which can then be used to generate commands to the display device 118 to simultaneously display the weather data with the georeferenced formatted data. The weather data may also provide trajectory data, such as altitudes for storm cells (“tops”) and direction of movement of the storm cells. This type of data could also be displayed simultaneously with the storm cells.

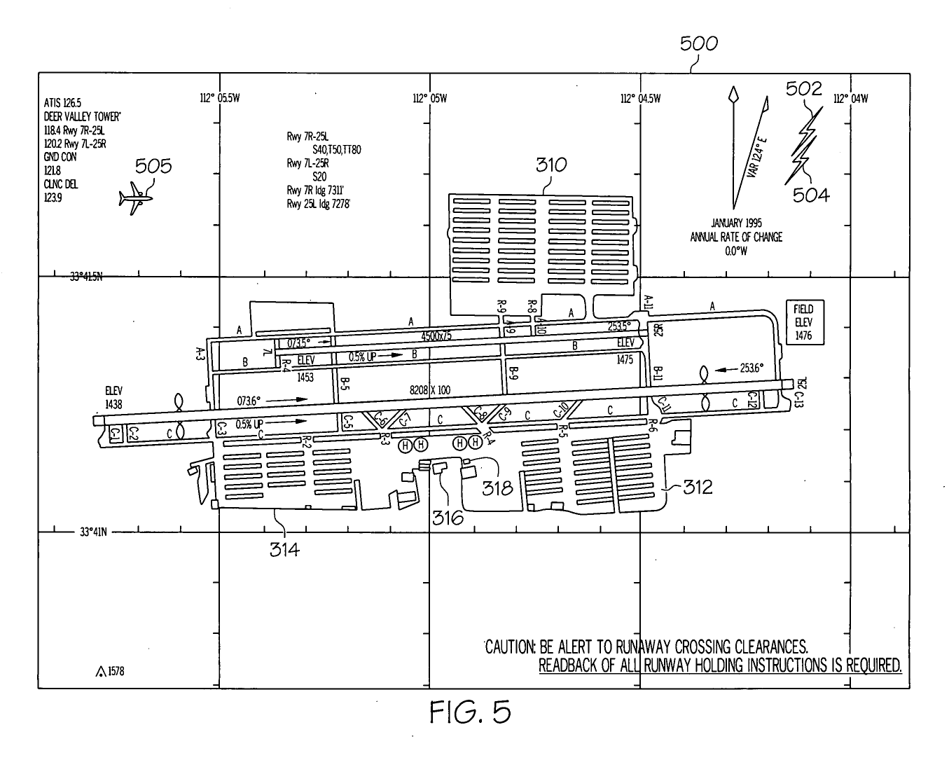

In FIG. 5, lightning strike locations 502, 504 are included in an image 500 depicting an electronic aeronautical chart having an aircraft symbol 505 and airport objects. The lightning strike locations are obtained by a lightning sensor, which senses the locations in a non-georeferenced format. The processor 104 converts the sensed data into a georeferenced format and supplies appropriate commands to the display device 118 to simultaneously display the lightning strike locations with the aircraft symbol 505 and airport objects.

Although each example shows one type of non-georeferenced data displayed on the electronic aeronautical chart, it will be appreciated that more than one type of non-georeferenced data may be alternatively simultaneously displayed. Furthermore, it will be appreciated that any non-georeferenced formatted data capable of being converted into geographic coordinates by the processor 104 may be displayed simultaneously with any electronic aeronautical chart that may be stored as georeferenced formatted data. Moreover, although the images 300, 400, 500 show a north up orientation, it will be appreciated that other images may show a heading up orientation or a track orientation, and the non-georeferenced data may be displayed relative thereto. The above-described methods and devices for simultaneously displaying these two types of data is more user-friendly and presents the electronic aeronautical charts in a manner that is easier for the user to process.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for displaying flight-related data on a display in an aircraft, the method comprising the steps of:
displaying an electronic aeronautical chart comprising georeferenced formatted data;
converting non-georeferenced flight hazard data into a georeferenced format; and
displaying the converted flight hazard data on the electronic aeronautical chart.

2. The method of claim 1, wherein the non-georeferenced flight hazard data comprises trajectory data and the method further comprises associating trajectory data with non-georeferenced flight hazard data.

3. The method of claim 2, wherein the step of displaying comprises simultaneously displaying the converted non-georeferenced flight hazard data and the associated trajectory data on the electronic aeronautical chart.

4. The method of claim 3, wherein the step of converting comprises converting a bearing and a distance measurement of another aircraft into a geographic coordinate and the step of displaying the converted flight hazard data comprises displaying the geographic coordinate as a symbol representing the other aircraft.

5. The method of claim 4, wherein the step of displaying the converted flight-related data and the associated trajectory data comprises associating a relative altitude with the other aircraft symbol and displaying the relative altitude with the other aircraft symbol.

6. The method of claim 1, wherein the step of converting comprises converting data selected from at least one datapoint selected from the group consisting of traffic and collision avoidance data, terrain avoidance and warning data, and weather data.

7. The method of claim 1, wherein the step of displaying an electronic aeronautical chart comprises displaying a plurality of fixed airport objects.

8. The method of claim 1, wherein the step of displaying an electronic aeronautical chart comprises displaying at least one flight route.

9. The method of claim 8, wherein the step of displaying an electronic aeronautical chart comprises displaying a grid including a plurality of latitude and longitude lines and the plurality of fixed airport objects relative to the latitude and longitude lines.

10. The method of claim 1, further comprising displaying an aircraft symbol on the display representing the aircraft at a present position.

11. A display system for a vehicle, comprising:
a processor adapted to receive georeferenced formatted data representing an electronic aeronautical chart, to receive and convert non-georeferenced flight hazard data into a georeferenced format, and operable, in response to receiving and converting, to supply one or more image rendering display commands; and
a display device coupled to receive the image rendering display commands and operable, in response thereto, to simultaneously render the electronic aeronautical chart and the converted flight hazard data on the electronic aeronautical chart.

12. The system of claim 11, wherein:
the processor is further adapted to associate the converted flight hazard data with non-georeferenced trajectory data and to supply one or more image rendering display commands in response thereto; and
the display device, in response to the image rendering display commands, is operable to simultaneously render the converted flight hazard data and the associated non-georeferenced trajectory data on the electronic aeronautical chart.

13. The system of claim 12, wherein the processor is further adapted to convert a bearing and a distance measurement of another aircraft into a geographic coordinate and to supply one or more image rendering display commands, in response thereto, and the display device, in response to the image rendering commands, is operable to render the converted bearing and distance measurement as a symbol representing the other aircraft.

14. The system of claim 13, wherein the processor is further adapted to associate a relative altitude with the other aircraft symbol and to supply one or more image rendering commands, in response thereto, and the display device, in response to the image rendering commands, is operable to render the relative altitude with the other aircraft symbol.

15. The system of claim 11, wherein the processor is adapted to receive and to convert data selected from at least one datapoint selected from the group consisting of traffic and collision avoidance data, terrain avoidance and warning data, and weather data and to supply one or more image rendering display commands, in response thereto, and the display device, in response to the image rendering commands, is operable to render the data thereon.

16. The system of claim 11, wherein the electronic aeronautical chart comprises a plurality of fixed airport objects.

17. The system of claim 11, wherein the electronic aeronautical chart comprises at least one flight route.
